(19) United States
(12) Patent Application Publication
(10) Pub. No.: US 2011/0007719 A1
(43) Pub. Date: Jan. 13, 2011

(54) METHOD FOR SETTING TRANSMISSION TIMING OF WIRELESS COMMUNICATION APPARATUS

(76) Inventor: Chi-Chen Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/622,442

(22) Filed: Nov. 20, 2009

Related U.S. Application Data
(60) Provisional application No. 61/275,691, filed on Nov. 26, 2008.

(51) Int. Cl. H04J 3/00

(52) U.S. Cl. 370/336

(57) ABSTRACT

A method for setting an uplink transmission timing of a wireless communication apparatus, comprises: acquiring an initial uplink transmission advance timing by an initial ranging procedure during the wireless communication apparatus being served by SBS; receiving a downlink preamble signal from SBS; determining the downlink preamble signal receiving time at the wireless communication apparatus; and, setting an uplink transmission timing for the wireless communication apparatus according to the acquired initial uplink transmission advance timing and the downlink preamble signal receiving time. Another method comprises: acquiring an initial uplink transmission advance timing by an initial ranging procedure during the wireless communication apparatus being served by SBS; handing over the wireless communication apparatus to TBS from SBS; and, updating the uplink transmission timing for the wireless communication apparatus according to the acquired initial uplink transmission advance timing and the difference of receiving times of downlink preamble signals transmitted from SBS and TBS.

### CROSS REFERENCE TO RELATED APPLICATIONS

This application claims the benefit of U.S. non-provisional application Ser. No. 12/323,480, filed on Nov. 26, 2008 and incorporated herein by reference, where a petition to convert the U.S. non-provisional application Ser. No. 12/323,480 into a provisional applicant pursuant to 37 C.F.R. 1.53(c)(2) was filed on Sep. 24, 2009.

### BACKGROUND

The invention relates to wireless communication systems, and more particularly, to a method for setting the uplink transmission timing of a wireless communication apparatus in the wireless communication system by utilizing the initial uplink transmission advance timing and updating the uplink transmission timing of a wireless communication apparatus in the wireless communication system.

In wireless communication systems, for reusing radio resources, cellular-based wireless communication systems are frequently adopted. FIG. 1 is a diagram illustrating a configuration of a wireless communication system introducing the cellular concept. Referring to FIG. 1, the wireless communication system comprises two base stations BS1 and BS2, each of which manages its own cell. The mobile stations MS1, MS3, and MS5 are managed by the BS1, and mobile stations MS2 and MS4 are managed by the BS2. The BS1 and BS2 are connected to each other through wireless or wired connection (not shown in FIG. 1) for information exchange. The mobile stations MS1-MS5 are respectively linked to the BS1 and BS2 through radio links (not shown in FIG. 1) between them.

The mobile stations may arbitrarily move around. While a mobile station (e.g. MS1) is moving away from a serving base station (BS1) towards a neighboring base station (BS2) and the MS1 is not appropriate to be managed by the BS1 any more, the MS1 should be handed over to the BS2 (i.e. a target base station) from the BS1. However, there are several issues need to be negotiated prior performing the handover. For example, it has to be determined whether the target base station is available to accept the MS1, the target base station can provide a better service to the MS1, and whether the MS1 can obtain the appropriate power, frequency, and timing for communicating with the target base station, etc.

Measuring the appropriate power, frequency, and timing for communicating with the target base station is also referred to as the “ranging” procedure. The conventional ranging procedure, however, is time consuming, which delays the entire handover process. Some developments are dedicated to simplify the complicated handover process for reducing the handover time-period. For example, when using “fast ranging”, the mobile station may adjust the uplink transmission timing without performing the uplink ranging to the target base station. The conventional method is that the mobile station calculates the downlink signal arrival time difference between the serving base station and the target base station through scanning before handing over to the target base station, and estimates the uplink transmission timing for communicating with the target base station according to the downlink signal arrival time difference. This approach, however, has some drawbacks. The mobile station has to execute extra measurements and calculations while scanning the potential target base stations neighboring the serving base station, which also increases the burden of performing the handover. Furthermore, the estimated uplink transmission timing is not up-to-date as the handover starts. To estimate updated transmission timing, the scanning operation has to be executed constantly before the handover; however, it may not have enough time to perform negotiation for scanning between the serving base station and the potential target base stations. In addition, when the mobile station decides to cancel the handover and return to previous base station, the estimated uplink transmission timing may not be up-to-date or appropriate for communicating with the previous base station.

### SUMMARY

To solve the above problems, the invention provides a method for setting a transmission timing of a wireless communication apparatus. The provided method can not only reduce extra procedures before handover and increase the speed of handover. Furthermore, the method also provides accurate and up-to-date transmission timing.

A method for setting an uplink transmission timing of a wireless communication apparatus, comprises: acquiring an initial uplink transmission advance timing by an initial ranging procedure during the wireless communication apparatus being served by a serving base station (SBS); updating the uplink transmission advance timing through periodic ranging procedures; receiving a downlink preamble signal from the SBS; determining the downlink preamble signal receiving time at the wireless communication apparatus; and, setting an uplink transmission timing for the wireless communication apparatus according to the acquired initial or updated uplink transmission advance timing and the downlink preamble signal receiving time. In addition, a method for setting an initial uplink transmission advance timing of a wireless communication apparatus, comprises: acquiring an initial uplink transmission advance timing by an initial ranging procedure during the wireless communication apparatus being served by a serving base station (SBS); updating the uplink transmission advance timing through periodic ranging procedures; handing over the wireless communication apparatus to a target base station (TBS) from the SBS; and, updating the uplink transmission timing for the wireless communication apparatus according to the acquired initial or updated uplink transmission advance timing at SBS and the difference of receiving times of downlink preamble signals transmitted from the SBS and the TBS

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a configuration of a wireless communication system introducing the cellular concept.

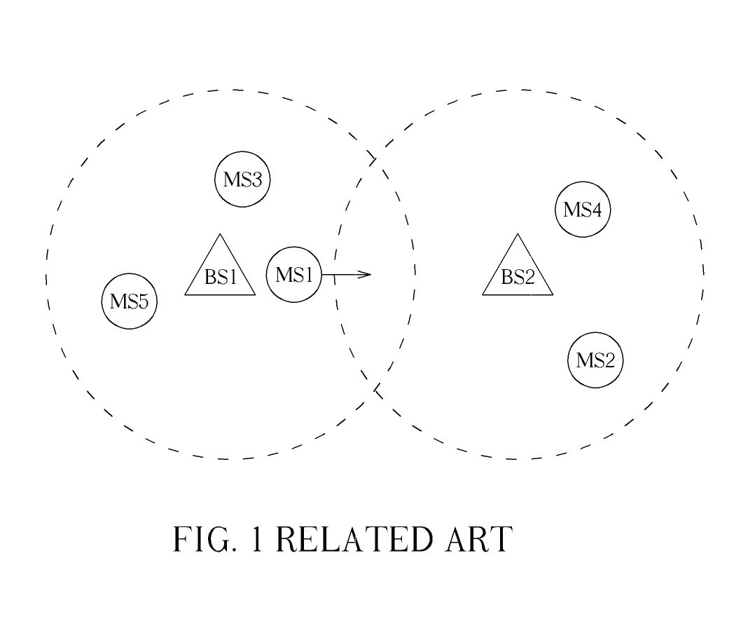

FIG. 2 is a diagram illustrating a configuration of a wireless communication system introducing the cellular concept according to an embodiment of the invention.

FIG. 3 is a signaling diagram illustrating the handover procedure of the MS relating to the transmission timing setting.

FIG. 4 is a flowchart of a method for setting a transmission timing of a mobile station according to an embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Several preferred embodiments of the present invention will now be described in detail with reference to the annexed drawings. In the following description, a detailed description of known functions and configurations incorporated herein has been omitted for conciseness.

The invention provides a method for setting a transmission timing of a wireless communication apparatus in a wireless communication system. The wireless communication system can be any communication system having a plurality of base stations, e.g. Worldwide Interoperability for Microwave Access (WiMAX) system, WiMAX system conforming to the Institute of Electrical and Electronics Engineers (IEEE) 802.16 standard, Global System for Mobile (GSM), Long Term Evolution (LTE), 3 G communication system, and other OFDMA communication system, etc. The wireless communication apparatus can be served or managed by the base station, e.g. a mobile station in a WiMAX system. The transmission timing comprises an uplink transmission timing and a downlink transmission timing for communicating with the base station.

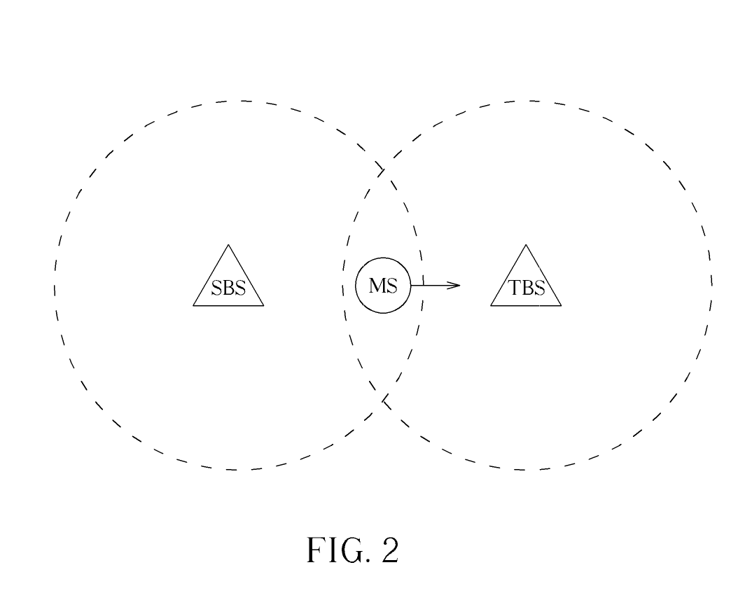

FIG. 2 is a diagram illustrating a configuration of a wireless communication system introducing the cellular concept according to an embodiment of the invention. A mobile station MS is initially served by a serving base station (SBS), then moves away from the SBS toward to a target base station (TBS) neighboring to the SBS. Since the MS is moving away from the SBS, a signal strength of downlink signals transmitted from the SBS becomes weaker, and a carrier-to-interference and noise ration (CINR) value of the downlink signals transmitted from the BS may drop below an acceptable threshold. The MS may obtain a better communication service by handing over to the TBS.

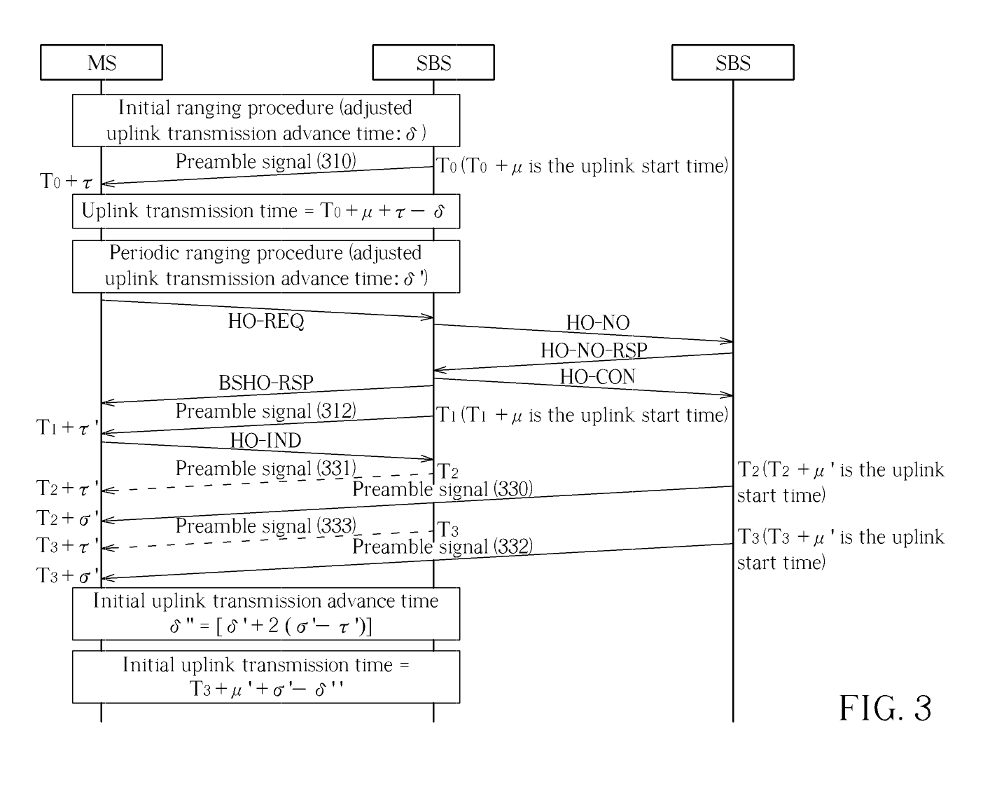

FIG. 3 is a signaling diagram illustrating the handover procedure of the MS relating to the transmission timing setting, where details of other well known processes (e.g. power setting and carrier frequency setting, etc) are omitted for brevity. The MS obtains an initial uplink transmission advance timing δ by an initial ranging procedure and updates the following uplink transmission advance timing δ′ by a periodic ranging procedure. As shown in FIG. 3, the uplink transmission timing after initial ranging procedure will be T₀+τ+μ−δ instead of T₀+τ+μ. The uplink transmission start time is fixed and specified by SBS but the uplink transmission advance timing is different for each MS due to the multi-path propagation and the round trip delay differences, which is the dominate factor. The SBS periodically transmits downlink preamble signals 310 and 312 at T₀ and T₁. The MS receives downlink preamble signals 310 and 312 from the SBS at T₀+τ and T₁+τ′ while being served by the SBS. The actual downlink preamble signal receiving time (T₀+τ and T₁+τ′) at MS may be changed due to the multi-path propagation and the round trip delay differences as the distance between the SBS and the MS changes. The MS may adjust the downlink reception timing for communicating with the SBS through each downlink preamble signal received from the SBS. In addition, the MS can generate and correct its own clock based on the downlink preamble signals. Please note μ is an offset value for the uplink start time that estimated or determined by SBS. For simplicity, the μ is assumed to be zero (e.g. T₀+μ=T₀)

In one embodiment, the SBS periodically transmits its downlink preamble signals 310 and 312 at T₀ and T₁. The MS receives the periodic downlink preamble signal 310 and 312 at T₀+τ and T₁+τ′. The MS obtains the initial uplink transmission advance timing (δ) by initial ranging procedure and updates the following uplink transmission advance timing (δ′) according to SBS instruction (i.e. periodic ranging procedure) or MS itself based on observation of SBS downlink preamble signal arrival time variation while being served by the SBS. The TBS periodically transmits its downlink preamble signals 330 and 332 at T₂ and T₃. The SBS also transmits its downlink preamble signals 331 and 333 at T₂ and T₃ since SBS and TBS are timing synchronous. The MS receives the downlink preamble signal of TBS 330 and 332 at T₂+σ and T₃+σ′ after sending MOB_HO-IND message 326. The SBS downlink preamble signal 312 is the last downlink preamble signal received by the MS at SBS and last timing difference is τ′. The latest updated uplink transmission advance timing is δ′. The downlink preamble signal reception timing at TBS is denoted as T₂+σ and T₂₃+σ′ and if the MS is still served by the SBS, the MS will receive downlink signals 331 and 333 from the SBS at T₂+τ′ and T₃+τ′. The MS can directly derive the initial uplink transmission advance timing for communicating with the TBS without scanning records of the TBS and initial or handover ranging procedure. For example, the initial uplink transmission advance timing δ″ is determined according to the difference of the receiving time of the downlink preamble signals 332 and 333 (note that MS only receive preamble signal 332 from TBS, however, MS will keep the timing difference τ′ and therefore assume the virtual receiving time of the SBS preamble signal is T₃+τ′), δ″ equals to [δ′+2(σ′-τ′)]. And the final initial uplink transmission timing is T₃+σ′+μ′−δ″ if MS needs to transmit data at the frame that preamble signal is sent at T₃. Note that σ may or may not equal to σ′ and (σ′−τ′) can be less, equal or greater than zero. The initial uplink transmission timing can be deemed as an estimation of initial uplink transmission timing for communicating with the TBS. It should be appreciated the present invention provides the scheme that the arrival time difference between SBS and TBS do not need to be calculated before handover to TBS.

The MS transmits a handover request message (HO-REQ) 320 to the SBS for handover to the TBS. The SBS notifies the TBS of the handover request by the MS using a handover notification message (HO-NO) 321. Then the TBS informs the SBS whether to accept the handover, using a handover notification response message (HO-NO-RSP) 322. Then the SBS receives the HO-NO-RSP 322, and determines the TBS as a target base station to which the MS will be handed over (assuming the TBS can accept the MS). Thereafter, the SBS transmits a handover confirm message (HO-CON) 324 to the TBS, and then notifies the MS to accept the handover in response to the HO-REQ 320 from the MS, using a handover response message (HO-RSP) 325. Thereafter, the MS transmits a handover indication message (HO-IND) 326 to the SBS for making a final handover decision. In some embodiments with the channel condition is harsh, HO-IND 326 may not be sent by MS or received by SBS.

In one exemplary embodiment of the present invention, the MS can utilize an autonomous transmitting timing adjustment to adjust the following TBS downlink preamble signal reception timing according to the previous TBS downlink preamble signal reception. The autonomous transmitting timing adjustment comprises the MS autonomously adjusting uplink transmission timing according to the timing advances and retardations of the detected downlink preamble signal. At the MS, the transmitted radio frame will be time-aligned with the network specified uplink frame boundary. At zero timing advance and retardation setting, the start of the first uplink data symbol will be time aligned with the specified uplink frame boundary relative to the downlink preamble signal arrival time when measured at the antenna port without base station close-loop control.

For example, if the downlink signal 330 received from the TBS falls behind the virtual SBS downlink preamble transmission timing (i.e. σ>τ′), this means that the round trip delay between the MS and TBS is greater than the round trip delay between the MS and SBS. The initial uplink transmission advance timing for communicating with the TBS should be advanced so the uplink signal can be transmitted earlier to compensate for the greater round trip delay. In contrast, if the MS detects the downlink preamble signal transmitted from the TBS is in advance of the virtual SBS downlink preamble transmission timing (i.e. σ<τ′), this means that the round trip delay between the MS and TBS is shorter than the round trip delay between the MS and SBS, and therefore the MS will delay the initial uplink transmission advance timing to compensate for the shorter round trip delay.

Since the initial uplink transmission advance timing can be deemed as the estimation timing for communicating with the TBS, the estimation can be made based on different concerns. In the above embodiment, the initial uplink transmission advance timing is determined or estimated based on the latest uplink transmission advance timing for communicating with the SBS and the difference of the receiving time of the downlink preamble signals at SBS and TBS, which is a reasonable assumption provided that the round trip delays and channel conditions for communicating with the SBS and TBS are similar. In another embodiment, the initial uplink transmission advance timing can be arbitrarily determined by the MS without referring to the transmission timing for communicating with the SBS during the MS being served by the SBS. For example, the initial uplink advance transmission timing can be determined equal to the latest uplink transmission advance timing for communicating with the SBS.

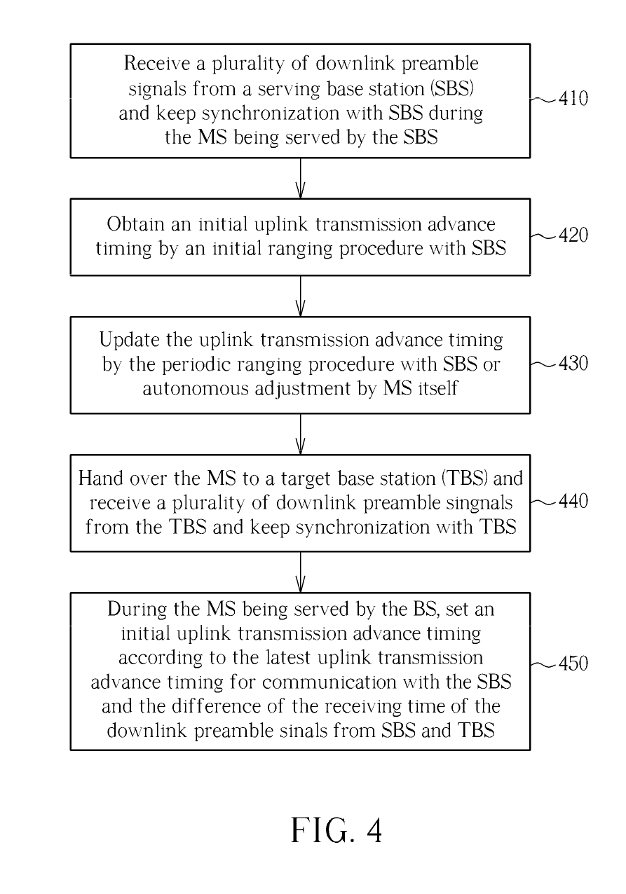

FIG. 4 is a flow chart of a method for setting a transmission timing of a mobile station (MS) according to an embodiment of the invention. The method comprises the following steps:

Step 410: Receive a plurality of downlink preamble signals from a serving base station (SBS) and keep synchronization with SBS during the MS being served by the SBS.

Step 420: Obtain an initial uplink transmission advance timing by initial ranging procedure with SBS

Step 430: Update the uplink transmission advance timing by periodic ranging procedure with SBS or autonomous adjustment by MS itself.

Step 440: Hand over the MS to a target base station (TBS) and receive a plurality of downlink preamble signals from a target base station (TBS) and keep synchronization with TBS.

Step 450: During the MS being served by the TBS, setting an initial uplink transmission advance timing according to the latest uplink transmission advance timing for communicating with the SBS and the difference of the receiving time of the downlink preamble signals from SBS and TBS.

In step 410, the MS is served by the SBS and receives a plurality of downlink signals (e.g. downlink signals 310 and 312 in FIG. 3) from the SBS and keep synchronization with SBS. In step 420, the MS obtains the initial uplink transmission advance timing by initial ranging procedure with SBS. In step 430, the MS updates the uplink transmission advance timing by periodic ranging procedure with SBS or autonomous adjustment by MS itself. The MS detects that the CINR value of the downlink signals transmitted from the SBS drops below an acceptable threshold and desires to hand over to other base stations for better service. The MS does not have to scan all the base stations neighboring the SBS for the purpose of calculating the difference of the receiving time of the downlink preamble signals at SBS and TBS and store all the receiving timing of downlink signals corresponding to the neighboring base stations. The MS only has to copy the latest uplink transmission advance timing for communicating with the SBS as the initial transmission timing and calculate initial uplink transmission advance timing for communicating with TBS based on the difference of the receiving time of the downlink preamble signals at SBS and TBS, which greatly simplifies the transmission timing determining procedure before performing the handover and increases the probability of successful handover. In step 440, the MS is handed over to the TBS and receive a plurality of downlink preamble signals from a target base station (TBS) and keep synchronization with TBS.

In step 450, while being served by the TBS, the MS set an initial uplink transmission advance timing according to the latest uplink transmission advance timing for communicating with the SBS and the difference of the receiving time of the downlink preamble signals at SBS and TBS. In addition, the uplink transmission timing for communicating with the TBS can be adjusted by the MS autonomously and continuously before the MS transmits an uplink signal to the TBS. The accuracy of initial uplink transmission advance timing can therefore be guaranteed.

To conclude, the embodiments of the invention provide a method for setting and autonomously adjusting the transmission timing for wireless communication apparatuses during handover. The method sets an initial uplink transmission advance timing for communicating with a new base station that the MS is handed over to according to a latest uplink transmission advance timing and downlink preamble signal reception timing for communicating with a previous base station that the MS is handed over from without scanning base stations neighboring the previous base station for the purpose of calculating the difference of the receiving time of the downlink preamble signals at SBS and TBS. In addition, one of advantage of the embodiment of the invention is to avoid calculating the difference of the receiving time of the downlink preamble signals at SBS and TBS during scanning process. The method also adjusts the initial uplink transmission advance timing of the MS for communicating with the new base station according to the downlink preamble signals received from the new base station. In this way, extra procedures (e.g. scanning neighboring base stations and storing corresponding downlink signal timing) can be omitted before handover, and therefore, the speed of handover can be increased. In addition, the transmission timing for communicating with the new base station is accurate and up-to-date, even while the wireless communication apparatus is being handed back to the previous base station soon.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for setting an uplink transmission timing of a wireless communication apparatus, comprising:
acquiring an initial uplink transmission advance timing by an initial ranging procedure during the wireless communication apparatus being served by a serving base station (SBS);
receiving a downlink preamble signal from the SBS;
determining the downlink preamble signal receiving time at the wireless communication apparatus; and,
setting an uplink transmission timing for the wireless communication apparatus according to the acquired initial uplink transmission advance timing and the downlink preamble signal receiving time.

2. The method of claim 1, further comprising:
updating the initial uplink transmission advance timing by a periodic ranging procedure.

3. The method of claim 1, further comprising:
updating the initial uplink transmission advance timing by an autonomous adjustment by the wireless communication apparatus.

4. The method of claim 1, further comprising:
handing over the wireless communication apparatus to a target base station (TBS) from the SBS.

5. The method of claim 4, wherein the wireless communication apparatus does not need to scan all base stations neighboring the SBS for the purpose of calculating the difference of the receiving time of the downlink preamble signals at SBS and TBS.

6. The method of claim 4, wherein the wireless communication apparatus does not need to calculate the difference of the receiving time of the downlink preamble signals at SBS and TBS during scanning process.

7. The method of claim 4, wherein the wireless communication apparatus does not need to store all neighboring base stations' downlink preamble signals' receiving timings.

8. The method of claim 4, further comprising:
updating the initial uplink transmission advance timing for the wireless communication apparatus while the wireless communication apparatus is being served by the TBS,
wherein the updating the initial uplink transmission advance timing is determined in accordance with a previous initial uplink transmission timing, obtained while the wireless communication apparatus still communicates with the SBS.

9. The method of claim 8, wherein the wireless communication apparatus only updates the initial uplink transmission advance timing after switching to the TBS.

10. The method of claim 8, wherein the updating the initial uplink transmission advance timing further according to difference of receiving times of downlink preamble signals from SBS and TBS.

11. The method of claim 10, wherein the updating the initial uplink transmission advance timing comprising:
decreasing the initial uplink transmission advance timing when a latest downlink preamble signal received from the TBS is in advance of a latest downlink preamble signal received from the SBS.

12. The method of claim 10, wherein the updating the initial uplink transmission advance timing comprising:
increasing the initial uplink transmission advance timing when a latest downlink preamble signal received from the TBS falls behind a latest downlink preamble signal received from the SBS.

13. The method of claim 4, further comprising:
handing over back to the SBS from the TBS for the wireless communication apparatus; and,
applying a latest uplink transmission advance timing while the wireless communication apparatus still communicates with the SBS.

14. A method for setting an initial uplink transmission advance timing of a wireless communication apparatus, comprising:
acquiring an initial uplink transmission advance timing by an initial ranging procedure during the wireless communication apparatus being served by a serving base station (SBS);
handing over the wireless communication apparatus to a target base station (TBS) from the SBS; and,
updating the uplink transmission timing for the wireless communication apparatus to obtain an updated initial uplink transmission advance timing according to the acquired initial uplink transmission advance timing and the difference of receiving times of downlink preamble signals transmitted from the SBS and the TBS.

15. The method of claim 14, wherein updating the uplink transmission timing for the wireless communication apparatus is updating while the wireless communication apparatus is being served by the TBS.

16. The method of claim 15, wherein the acquired initial uplink transmission advance timing is a latest uplink transmission advance timing for communicating with the SBS.

17. The method of claim 14, wherein the updating the uplink transmission timing for the wireless communication apparatus is via a periodic ranging procedure.

18. The method of claim 14, wherein the updating the uplink transmission timing for the wireless communication apparatus is via an autonomous adjustment by the wireless communication apparatus.

19. The method of claim 14, wherein the wireless communication apparatus only updates the initial uplink transmission advance timing after switching to the TBS.

20. The method of claim 14, wherein the wireless communication apparatus does not need to scan all base stations neighboring the SBS for the purpose of calculating the difference of the receiving time of the downlink preamble signals at SBS and TBS.
